(19) United States
(12) Patent Application Publication
(10) Pub. No.: US 2006/0251907 A1
(43) Pub. Date: Nov. 9, 2006

(54) Surface protection film and method for producing the same

(76) Inventor: Kiyoshi Shimizu, Hyogo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/569,633

(22) PCT Filed: Aug. 31, 2004
(86) PCT No.: PCT/JP04/12529

§ 371 Date: Feb. 27, 2006

(30) Foreign Application Priority Data
Sep. 1, 2003 (JP) 2003-308402

(51) Int. Cl. B32B 9/04

(52) U.S. Cl. 428/447

(57) ABSTRACT

A surface-protective film and method for producing the same, more specifically a surface-protective film which itself has excellent surface flatness/smoothness, because it can be easily released from an adhesive silicone rubber layer which it protects, contains no residual solvent which may aversely affect adhesiveness of the adhesive silicone rubber layer to a semiconductor chip and semiconductor chip mounting, and has no adverse effect on surface flatness of the adhesive silicone rubber layer, and a method for producing the same. The surface-protective film, laminated at least on one side with a polysulfone-based resin layer (B) of polysulfone-based resin composition, is to protect the adhesive silicone rubber layer (C), and is formed by a polysulfone-based resin solution composition of at least one type of polysulfone resin dissolved in a mixed solvent comprising 3 or 4 specific components.

### BACKGROUNG OF THE INVENTION

1. Field of the Invention

The present invention relates to a surface-protective film and method for producing the same, more specifically a surface-protective film which can be easily released from an adhesive silicone rubber layer which it protects, contains no residual solvent which may aversely affect adhesiveness of the adhesive silicone rubber layer to a semiconductor chip and semiconductor chip mounting, and has no adverse effect on surface flatness of the adhesive silicone rubber layer, and a method for producing the same.

2. Description of the Prior Art

A semiconductor device, also referred to as a semiconductor element, holds a semiconductor chip in a package, and is used in control and arithmetic circuits for electronic computers, TV sets, DVDs, VTRs, radios, microwave ovens, automobiles, aircraft, chemical plants and so on.

There are many semiconductor device types, and some of the typical ones are illustrated in FIGS. 1 and 2. A semiconductor device is described by referring to FIG. 1. The device comprises the semiconductor chip 1 (sometimes referred to as a silicon wafer), i.e., IC, LIC or the like, at the center, adhesive silicone rubber layer 2 and semiconductor chip mounting 3 on which the chip is mounted. As illustrated, the layer 2 is attached to the chip 1 on one side and to the mounting 3 on the other side [This assembly condition may be described in this specification that the semiconductor chip 1 is attached to (or mounted on) the mounting 3 via the adhesive silicone rubber layer 2].

The adhesive silicone rubber layer works to attach the chip 1 to the mounting 3, and also to relax a stress between them.

The semiconductor chip 1 is connected to the circuit interconnection 4 by the bonding wire 5. The block comprising the semiconductor 1, adhesive silicone rubber layer 2, semiconductor chip mounting 3 and circuit interconnection 4 is sealed by an epoxy-based resin sealant to be protected from external dust, moisture, impact or the like, and also to release internally generated heat to the outside.

A semiconductor chip has been mounted on a semiconductor chip mounting by an adequate adhesive agent, e.g., liquid or pasty crosslinkable (or curable) silicone composition.

A silicone-based adhesive agent is of an organopolysiloxane with at least two alkenyl groups in the molecule, each bound to silicon atom, organopolysiloxane with at least two hydrogen atoms in the molecule, each bound to silicon atom, crosslinkable silicone composition at least comprising a hydrosilylation catalyst, or crosslinkable silicone composition with an organopolysiloxane having at least one alkoxy and alkenyl groups each bound to silicon atom or at least one hydrogen atom bound to silicon atom in the molecule as an adhesion promoter (e.g., refer to JP-A 3-157474 (claims and others)).

The above-described crosslinkable silicone compositions have a problem of weeping of the low-viscosity silicone oil from the composition during the crosslinking process to pollute the surrounding area. The low-viscosity silicone oil is very difficult to completely remove, because an organopolysiloxane as the major ingredient or as an adhesion promoter contains an organopolysiloxane of low polymerization degree. Therefore, use of the crosslinkable (curable) silicone composition for attaching the semiconductor chip and semiconductor chip mounting may cause insufficient reliability of the semiconductor device, resulting from deteriorated wire-bondability between the bonding pad and bonding wire or beam lead on the chip.

JP-A 11-12546 (claims, page 4 and others), for example, proposes techniques to solve these problems. More specifically, it discloses an adhesive silicone rubber layer (or sheet, a term which is sometimes used in this specification interchangeably with layer) which can prevent weeping of low-viscosity silicone oil during the crosslinking process, well attach a semiconductor chip and semiconductor chip mounting and, as a result, give a semiconductor device of high reliability; method for efficiently producing the adhesive silicone rubber layer which exhibits particularly high adhesiveness and gives a semiconductor device of high reliability; and semiconductor device of high reliability which includes a semiconductor chip and semiconductor chip mounting fixed by the adhesive silicone rubber layer.

The above-described adhesive silicone rubber layer, when its surface is directly exposed to an ambient atmosphere, will be contaminated with dust or moisture deposited on the surface, which deteriorates functions of the semiconductor chip and semiconductor chip mounting on which it is set. Therefore, it shall be coated with a surface-protective film to prevent contamination with dust or moisture.

Resins useful for the surface-protective film include fluorine, polyethylene, polypropylene, polyimide, polyester, polyether, polyether sulfone, epoxy and phenol resins (refer to, e.g., JP-A 11-12546 (claims, page 4 and others), JP-A 2000-80335 (claims, page 4 and others), JP-A 2001-19933 (claims, page 11 and others)).

However, these resins, when used for the surface-protective film, have their own problems.

A fluorine resin film, although readily releasable from an adhesive silicone rubber layer, involves a problem of deteriorated adhesiveness of the objects (i.e., semiconductor chip and semiconductor chip mounting) on the layer left by the film.

A polyethylene resin sheet and polypropylene resin sheet (or film or layer, which is used interchangeably with sheet), although inexpensive, involve a problem of difficulty in forming the adhesive silicone rubber layer of uniform thickness, because they have a melting point lower than temperature at which a silicone rubber composition is crosslinked and are themselves deformed during the crosslinking process accordingly.

A polyimide resin sheet, although very excellent in heat resistance, dimensional stability and the like, is expensive and rather insufficient in releasability from an adhesive silicone rubber layer.

A polyester resin (e.g., polyethylene terephthalate) sheet has insufficient releasability from an adhesive silicone rubber layer.

A polyether resin sheet is expensive and has very insufficient releasability from an adhesive silicone rubber layer.

A polyether sulfone (sometimes referred to as PES) has been used most widely for protective films because of its high releasability from an adhesive silicone rubber layer. However, punching out a laminate with a polysulfone-based resin sheet as a surface-protective film produces a lot of filamentous (or whisker-like) debris which, when contaminates the laminate, may cause insufficient adhesion of the adhesive silicone rubber layer which the resin sheet protects to the semiconductor chip and semiconductor chip mounting.

An epoxy resin sheet has been rarely used for protective films because of its very insufficient releasability from an adhesive silicone rubber layer.

A phenol resin sheet has been rarely used for protective films because of its very insufficient flexibility.

A common mold-releasing film (separator), which is surface-treated with a mold-releasing agent of silicone, involves a problem of deteriorated adhesiveness of the objects (i.e., semiconductor chip and semiconductor chip mounting) on an adhesive silicone rubber layer, when it is released therefrom.

On the other hand, JP-A 49-110725 (claims and others), for example, proposes a mixed solvent of highly polar, inert liquid (e.g., dimethylsulfoxide (DMSO) or dimethylformamide (DMF)) as the major component combined with an alicyclic ketone and highly volatile aliphatic ketone to prepare a solution composition of polysulfone-based resin (e.g., polyether sulfone resin) dissolved in the solvent.

However, the solution composition involves problems, e.g., insufficient surface flatness/smoothness of the coating layer it gives and discharge of toxic substances (e.g., SOx and NOx) when the solvent component evaporated during the solution coating and drying steps is incinerated for disposal.

Moreover, the solution composition of polysulfone-based resin becomes turbid when a polysulfone dimmer or the like is crystallized. The resulting film of the turbid solution has a high haze level and roughened surface. Therefore, it is filtered or heat-treated at 80° C. or higher prior to the film-making step (refer to, e.g., JP-A 5-329857 (claims and others), JP-A 7-233265 (claims and others), JP-A 7-268104 (claims and others)).

However, the filtration deteriorates productivity. The heat treatment also deteriorates productivity, because it needs a high-boiling solvent and hence a drying step of high temperature or long time. Therefore, these proposals cannot give a film of sufficient surface flatness/smoothness.

### SUMMARY OF THE INEVENTION

It is an object of the present invention, in consideration of the problems involved in the conventional techniques, to provide a surface-protective film which can be easily released from an adhesive silicone rubber layer which it protects, and has a flat/smooth surface because it contains no residual organic solvent which may aversely affect adhesiveness the adhesive silicone rubber layer to a semiconductor chip and semiconductor chip mounting, and has no adverse effect on uniform thickness and surface flatness/smoothness of the adhesive silicone rubber layer. It is another object of the present invention to provide a method for producing the same.

The inventor of the present invention has made a variety of prototype surface-protective films of various plastics and laminates each comprising a surface-protective film and adhesive silicone rubber layer, to extensively study releasability of the surface-protective film from the adhesive silicone rubber layer, effects on adhesiveness of the adhesive silicone rubber layer to a semiconductor chip and semiconductor chip mounting fixed on the layer, effects on surface flatness of the adhesive silicone rubber layer, surface flatness/smoothness of the surface-protective film itself, and so on, and found that a surface-protective film exhibits good properties, e.g., releasability, adhesiveness, surface flatness/smoothness described above, when its base film is laminated, at least on one side, with a polysulfone-based resin layer (B) of polysulfone-based resin composition formed with a mixed solvent of specific composition, achieving the present invention.

The first aspect of the present invention is a surface-protective film comprising a base film (A) which is laminated, at least on one side, with a polysulfone-based resin layer (B) to protect an adhesive silicone rubber layer (C), wherein the polysulfone-based resin layer (B) is of a polysulfone-based resin solution composition of at least one type of polysulfone-based resin dissolved in a mixed solvent comprising at least one of lactone (a) and aromatic ketone (b), cyclic ketone (c) and aliphatic ketone (d) boiling at 150° C. or lower.

The second aspect of the present invention is the surface-protective film of the first aspect, wherein the polysulfone-based resin layer (B) has surface smoothness with number of circular irregularities having a diameter of 50 μm or more, determined by a Nomarski differential interference microscope, of one or less per unit visual field area (1 mm²).

The third aspect of the present invention is the surface-protective film of the first aspect, wherein the base film (A) and polysulfone-based resin layer (B) are bonded to each other at an adhesive strength of 5 N/m or more.

The fourth aspect of the present invention is the surface-protective film of the first aspect, wherein the base film (A) is of polyethylene terephthalate.

The fifth aspect of the present invention is the surface-protective film of the first aspect, wherein the mixed solvent is contained in the film at 1000 mg/m² or less.

The sixth aspect of the present invention is the surface-protective film of the first aspect, wherein the base film (A) is 10 to 200 μm thick and the polysulfone-based resin layer (B) is 0.1 to 50 μm thick.

The seventh aspect of the present invention is the surface-protective film of the first aspect which is released from the adhesive silicone rubber layer (C) at a peel strength of 4 N/m or less.

On the other hand, the eighth aspect of the present invention is a method for producing the surface-protective film of one of the first to seventh aspects, wherein the polysulfone-based resin layer (B) is formed by spreading and drying a dope of polysulfone-based resin on at least one side of the base film (A).

As described above, the present invention relates to a surface-protective film and the like, the film comprising a base film (A) which is laminated, at least on one side, with a polysulfone-based resin layer (B) to protect an adhesive silicone rubber layer (C), wherein the polysulfone-based resin layer (B) is of a polysulfone-based resin solution composition of at least one type of polysulfone-based resin dissolved in a mixed solvent comprising at least one of lactone (a) and aromatic ketone (b), cyclic ketone (c) and aliphatic ketone (d) boiling at 150° C. or lower. The preferred embodiments of the film include the following.

(1) The surface-protective film of the first aspect, wherein the mixed solvent has a composition satisfying all of the following formulae (1) to (4), solvent component contents being % by volume based on the total mixed solvent.
60≧(a+b)≧15 (1)
65≧c≧10 (2)
45≧d≧10 (3)
a+b+c+d=100 (4)
(2) The surface-protective film of the first aspect, wherein the polysulfone-based resin is incorporated in the polysulfone-based resin solution composition at 1 to 30% by mass based on the mixed solvent.
(3) The surface-protective film of the first aspect, wherein the polysulfone-based resin is one of polysulfone (PSF), polyether sulfone (PES) and polyphenyl sulfone (PPSU) resin.
(4) The method of the eighth aspect, wherein the dope is of a polysulfone-based resin solution composition of at least one type of polysulfone-based resin dissolved in a mixed solvent comprising at least one of lactone (a) and aromatic ketone (b), cyclic ketone (c) and aliphatic ketone (d) boiling at 150° C. or lower.
(5) The method of the eighth aspect, wherein the dope is spread by wire bar coating.
(6) A laminate comprising the adhesive silicone rubber layer (C) laminated, at least on one side, with the surface-protective film of one of the first to seventh aspects.
(7) The laminate (6), wherein the surface-protective film is released from the adhesive silicone rubber layer (C) at a peel strength of 4 N/m or less.
(8) The laminate (6), wherein the adhesive silicone rubber layer (C) is laminated with the surface-protective films on both sides.
(9) The laminate (6), wherein a crosslinkable silicone rubber composition as a starting material for the adhesive silicone rubber layer (C) comprises (i) an organopolysiloxane with at least two alkenyl groups in the molecule, each bound to silicon atom, (ii) organopolysiloxane with at least two hydrogen atoms in the molecule, each bound to silicon atom, (iii) adhesion promoter and (iv) hydrosilylation catalyst.

The surface-protective film of the present invention brings an effect of causing no adverse effect on surface flatness/smoothness of the adhesive silicone rubber layer, because it can be easily released from the adhesive silicone rubber layer which it protects, contains no residual organic solvent which may aversely affect adhesiveness of the adhesive silicone rubber layer to the semiconductor chip and semiconductor chip mounting, and is excellent in surface flatness/smoothness of the film itself.

The present invention also brings an effect of producing a highly reliable semiconductor device, because the surface-protective film of the present invention can be easily released from the adhesive silicone rubber layer, and the adhesive silicone rubber layer is bonded to the semiconductor chip and semiconductor chip mounting at a high adhesive strength.

### BRIEF DESCRIPTION OF THE DRAWINGS

FIG. 1 is a cross-sectional view illustrating one example of the semiconductor device (including a hybrid IC) to which the laminate of the present invention is applied

FIG. 2 is a cross-sectional view illustrating one example of the semiconductor device (including an LSI) to which the laminate of the present invention is applied.

FIG. 3 illustrates composition of the 3 components of the mixed solvent for the polysulfone-based resin solution composition used in the present invention.

FIG. 4 is a cross-sectional view illustrating one example of the surface-protective film of the present invention.

FIG. 5 is a cross-sectional view illustrating one example of the laminate of A/B/C/B/A structure, as one of the applications of the surface-protective film of the present invention.

### NOTATION

1 Semiconductor chip
2 Adhesive silicone rubber layer
3 Semiconductor chip mounting (circuit board of epoxy resin)
4 Circuit board
5 Bonding wire
6 Sealant resin
7 Semiconductor chip mounting (circuit board of polyimide resin)
8 Bump
9 Sealant/filler
10 Base film layer (of PET)
11 Polysulfone-based resin layer (coating layer of polysulfone-based in)

### DETAILED DESCRIPTIONS OF THE INVENTION

The surface-protective film and method for producing the same, both of the present invention, are described in detail for each item.

The surface-protective film of the present invention comprises the base film (A) which is laminated, at least on one side, with the polysulfone-based resin layer (B) to protect the adhesive silicone rubber layer (C), wherein the polysulfone-based resin layer (B) is of a polysulfone-based resin solution composition of at least one type of polysulfone-based resin dissolved in a mixed solvent comprising at least one of lactone (a) and aromatic ketone (b), cyclic ketone (c) and aliphatic ketone (d) boiling at 150° C. or lower.

1. Base Film (A)

The base film (A) for the present invention works as a base for the surface-protective film of the present invention, responsible for mechanical strength of the surface-protective film and laminated, at least on one side, with the polysulfone-based resin layer (B).

Resins useful for the base film (sheet) (A) include polyethylene terephthalate, polybutylene terephthalate, polyethylene naphthalate, polybutylene naphthalate, polycarbonate, high-density polyethylene, linear, low-density polyethylene, polypropylene, poly-4-methylpentene-1, polystyrene, polysulfone (PSF), polyether sulfone (PES), polyphenyl sulfone (PPSU), polyphenylene sulfide, poly-p-phenylene-terephthalamide, polyamide, polyetheretherketone, polyacrylate, polyallylate, polyphenylene ether, polyacetal, methyl polymethacrylate, polyacrylonitrile, polyethylene chloride trifluoride, polyethylene tetrafluoride, polyparaxylene, polyetherimide, polyimide, polyvinyl chloride, polyurethane and epoxy resin. They may be used either individually or in combination.

For adhesion of the base film (A) to the polysulfone-based resin layer (B), they are bonded at an adhesive strength of 5 N/m or more, preferably 7 N/m or more, more preferably 10 N/m or more.

Of these resins satisfying the above condition, polyethylene terephthalate is most preferable for the base film (A), because it is highly adhesive to the polysulfone-based resin layer (B), can be laminated at an adhesive strength of 5 N/m or more, gives the film of uniform thickness, and is sufficiently elastic to be smoothly handled.

An adhesive strength below 5 N/m may be lower than a peel strength at which the film is released from the adhesive silicone rubber layer (C). In such a case, the object of the present invention will not be achieved, because the film will be separated from the polysulfone-based resin layer (B) instead from the adhesive silicone rubber layer (C) surface.

Thickness of the base film (A) is not limited. It is, for example, 10 to 200 μm, preferably 30 to 150 μm, more preferably 40 to 100 μm. When it is below 10 μm, the film may not be smoothly handled because of its insufficient elasticity. Thickness above 200 μm is also not desirable, because the film will be too elastic to be smoothly wound around a roll. It will also push up the material cost, cause overquality and hence push up the production cost.

The base film (A) may be incorporated with an antioxidant, thermal stabilizer, lubricant, pigment, anti-UV agent or the like, as required.

It may be treated with corona discharge or provided with an undercoating to improve adhesion in the interface with the polysulfone-based resin layer (B).

2. Polysulfone-Based Resin Layer (B)

The polysulfone-based resin layer (B) for the present invention provides an interface with the adhesive silicone rubber layer (C). Therefore, it shall be well releasable from the layer (C) and free of any component which can adversely affect properties related to adhesion of the layer (C) to the semiconductor chip and semiconductor chip mounting.

As described earlier, a polysulfone-based resin, e.g., polyether sulfone resin, has been most widely used for surface-protective films because of its good releasability from an adhesive silicone rubber layer. However, punching out a laminate of adhesive silicone rubber layer and polysulfone-based resin sheet as a surface-protective film by a Thomson punching machine produces a lot of filamentous (or whisker-like) debris which, when contaminates the laminate, may cause insufficient adhesion of the adhesive silicone rubber layer (C) to the semiconductor chip and semiconductor chip mounting.

In order to solve the debris-caused problems, the base film (A) for the surface-protective film of the present invention is laminated, at least on one side, with the polysulfone-based resin layer (B). Thickness of the polysulfone-based resin layer (B) is not limited. It is, for example, 0.1 to 50 μm, preferably 0.5 to 20 μm, more preferably 1 to 3 μm. Thickness beyond the above range is not desirable. It is difficult to form the polysulfone-based resin layer (B) when the sheet is thinner than 0.1 μm, and quantity of debris is increased when it is thicker than 50 μm.

A polysulfone-based resin has been used for coatings, paints, adhesive agents and so on, where it is normally dissolved in a solvent and the resulting solution composition is spread on a base material surface and dried to form the product.

In the present invention, a polysulfone-based resin solution composition is used to form the polysulfone-based resin layer (B). It has at least one type of polysulfone-based resin dissolved in a mixed solvent comprising at least one of lactone (a) and aromatic ketone (b), cyclic ketone (c) and aliphatic ketone (d) boiling at 150° C. or lower.

The mixed solvent uniformly dissolves the polysulfone-based resin, and the resulting solution composition gives the polysulfone-based resin layer (B) of excellent surface flatness/smoothness, when spread and dried.

(1) Mixed Solvent

The mixed solvent for the present invention is an organic mixed solution which can dissolve a polysulfone-based resin to form a polysulfone-based resin solution composition.

It comprises at least one of lactone (a) and aromatic ketone (b), cyclic ketone (c) and aliphatic ketone (d) boiling at 150° C. or lower, as described above, having a composition which satisfies all of the following formulae (1) to (4), solvent component contents being % by volume based on the total mixed solvent.
60≧(a+b)≧15 (1)
65≧c≧10 (2)
45≧d≧10 (3)
a+b+c+d=100 (4)
The preferable ranges of the formulae (1) to (3) are:
55≧(a+b)≧20
60≧c≧15
40≧d≧15
The more preferable ranges are:
50≧(a+b)≧20
55≧c≧20
40≧d≧20

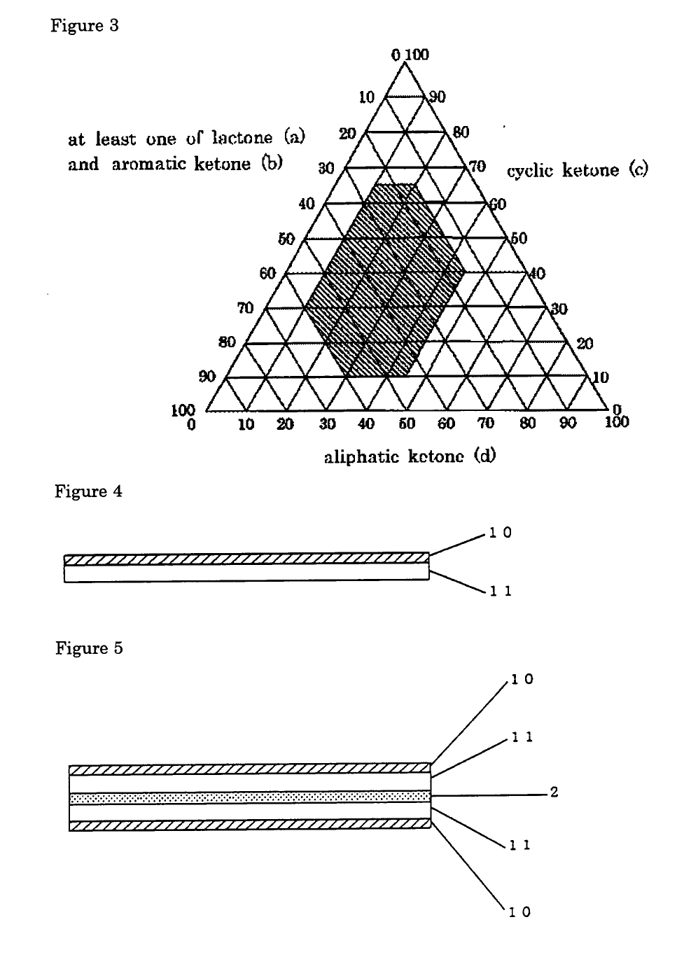

FIG. 3 presents a phase diagram of the 3-component system, showing the area in which all of the conditions (1) to (4) are satisfied.

A mixed solvent whose composition is outside of the above area, i.e., that fails to simultaneously satisfy the conditions (1) to (4), is not desirable, because it cannot fully dissolve a polysulfone-based resin or only swells/gelates the resin.

A 2-component mixed solvent, comprising 2 components selected from 3 or 4 components of at least one of lactone (a) and aromatic ketone (b), cyclic ketone (c) and aliphatic ketone (d) boiling at 150° C. or lower, cannot achieve excellent surface flatness/smoothness as the object of the present invention. Moreover, even a 3-component mixed solvent which cannot satisfy all of the conditions (1) to (4) will fail to achieve the object of the present invention and hence is not desirable.

It is considered, although not fully substantiated, that the 3-component mixed solvent of specific composition synergistically increases solubility of the polysulfone-based resin and disperses the resin, which is only swollen, in the aliphatic ketone (d) boiling at 150° C. or lower as a poor solvent, where the ketone (d) is a low-viscosity component and works to decrease viscosity of the solution. As a result, the solution of decreased viscosity can be spread to form the film of high surface flatness/smoothness.

(2) Lactone (a) or Aromatic Ketone (b)

The lactone (a) or aromatic ketone (b) component for the present invention may be one or more of the solvents described below in detail.

A lactone (a) is a cyclic compound having an ester group (—CO—O—) in the ring. These compounds include β-propiolactone (boiling point: 100 to 102° C.), γ-butyrolactone (boiling point: 206° C.), γ-valerolactone (boiling point: 206 to 207° C.), δ-valerolactone (boiling point: 218 to 220° C.), ε-caprolactone (boiling point: 235.3° C.), ethylene carbonate (boiling point: 238° C.), propylene carbonate (boiling point: 90° C., @5 mmHg), hinoki thiol (boiling point: 140 to 141° C., @10 mmHg) and diketene (boiling point: 127.4° C.), wherein each boiling point shown in the parentheses is a level at 103.3 kPa (760 mmHg) unless a measurement pressure is described. These compounds may be used either individually or in combination.

γ(Gamma)-butyrolactone (GBL) as one of the representative lactones is represented by the chemical formula (1):

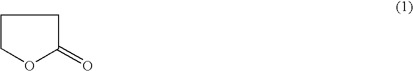

An aromatic ketone (b) is a ketone having an aromatic ring group. These compounds include acetophenone (boiling point: 202° C.), p-methylacetophenone (boiling point: 228° C.), propiophenone (boiling point: 218° C.), 1-phenyl-1-butanone (boiling point: 218 to 221° C.), isopropylphenylketone (boiling point: 217° C.), benzaldehyde (boiling point: 179° C.), o-hydroxybenzaldehyde (boiling point: 196 to 197° C.), m-hydroxybenzaldehyde (boiling point: 191, @50 mmHg), p-hydroxybenzaldehyde (boiling point: 116 to 117° C.) and benzylmethylketone (boiling point: 216° C.), wherein each boiling point shown in the parentheses is a level at 103.3 kPa (760 mmHg) unless a measurement pressure is described. These compounds may be used either individually or in combination.

Acetophenone as one of the representative aromatic ketones is represented by the chemical formula (2): 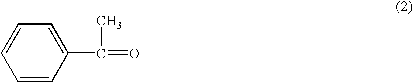
(3) Cyclic Ketone (c)

A cyclic ketone (c) is a cyclic compound having a ketone group (—CO—) in the ring. These compounds include cyclobutanone (boiling point: 100 to 102° C.), cyclopentanone (boiling point: 130° C.), cyclohexanone (boiling point: 156.7° C.), heptanone (boiling point: 179 to 181° C.), methylcyclohexanone (boiling point: 165 to 166° C.), cyclooctanone (boiling point: 74° C., @1.6 kPa), cyclononanone (boiling point: 93 to 95° C., @1.6 kPa), cyclodecanone (boiling point: 107° C., @1.7 kPa), cycloundecanone (boiling point: 108° C., @1.6 kPa), cyclododecanone (boiling point: 125° C., @ 1.6 kPa) and cyclotridecanone (boiling point: 138° C., @1.6 kPa), wherein each boiling point shown in the parentheses is a level at 103.3 kPa (760 mmHg) unless a measurement pressure is described. These compounds may be used either individually or in combination.

Cyclohexanone as one of the representative cyclic ketones is represented by the chemical formula (3): 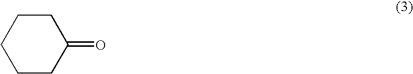
(4) Aliphatic Ketone (d)

An aliphatic ketone (d) for the present invention is an aliphatic ketone boiling at 150° C. or lower. These compound include acetone (boiling point: 100 to 102° C.), methylethylketone (boiling point: 100 to 102° C.), methylpropylketone (boiling point: 100 to 102° C.), methylisobutylketone (boiling point: 100 to 102° C.), methyl-n-butylketone (boiling point: 100 to 102° C.), methyl-sec-butylketone (boiling point: 100 to 102° C.), diisobutylketone (boiling point: 100 to 102° C.), pinacolone (boiling point: 106.4° C.), methylisoamylketone (boiling point: 144.9° C.), diethylketone (boiling point: 101.8° C.), diisopropylketone (boiling point: 125.0° C.), ethylpropylketone (boiling point: 123.2° C.) and butylethylketone (boiling point: 147.3° C.), wherein each boiling point shown in the parentheses is a level at 103.3 kPa (760 mmHg). These compounds may be used either individually or in combination.

Methylethylketone (MEK) as one of the representative aliphatic ketones (d) is represented by the chemical formula (4): 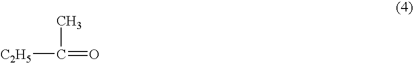
(5) Polysulfone-Based Resin

The polysulfone-based resin for the present invention is a thermoplastic resin having an aromatic ring group and sulfone group in the main chain, the latter working as a coupling group for the former. These compounds broadly fall into 3 general categories, polysulfone, polyether sulfone and polyphenyl sulfone.

Polysulfone resin (sometimes referred to as PSF) is a polymer typically having a structure represented by the chemical formula (5). It was disclosed by US's Union Carbide in 1965.

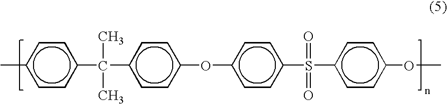

The polymer represented by the chemical formula (5) is produced from an alkali (Na) salt of bisphenol A and chlorinated bisphenol S (4,4′-dichlorodiphenylsulfone) as starting materials by sodium chloride dechlorination. The polymers useful for the present invention, represented by the chemical formulae (6) to (13), can be produced when bisphenol A is substituted by 4,4′-dihydroxy-diphenyl-oxide, 4,4′-dihydroxy-diphenyl-sulfide, 4,4′-dihydroxy-diphenyl-methane, 4,4′-dihydroxy-diphenyl-phenylethane, 4,4′-dihydroxy-diphenyl-perfluoropropane, hydroquinone, 4,4′-dihydroxybenzophenone, 4,4′-dihydroxy-diphenyl or the like.

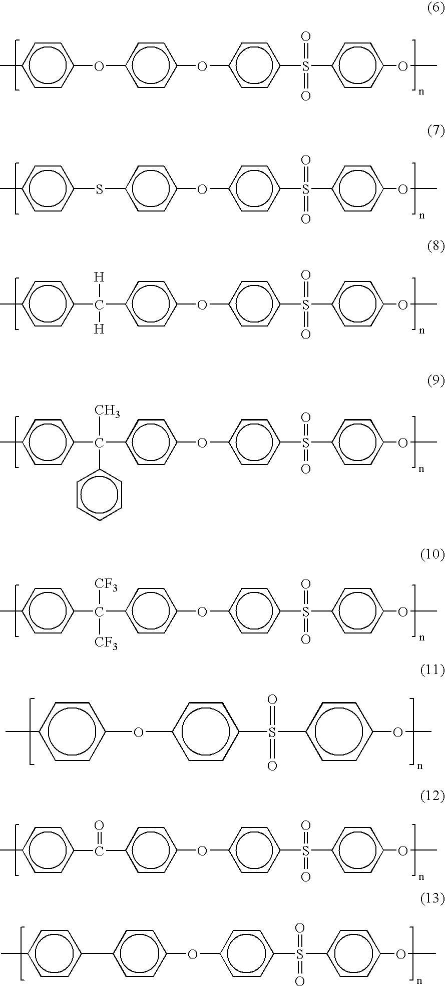

The commercial PSF products useful for the present invention include Udel® (produced by US's Amoco, and imported/sold by Teijin-Amoco Engineering) and Udel P-3500® (produced/sold by Nissan Chemical Industries).

Polyether sulfone resin (sometimes abbreviated by PES) a polymer typically having a structure represented by the chemical formula (14).

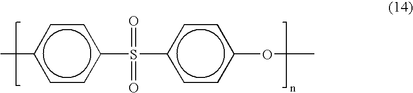

PES can be produced by the Friedel-Crafts reaction of diphenyl ether chlorosulfone.

The commercial PES products useful for the present invention include Ultrason® (produced by German's BASF, and imported/sold by Mitsui Chemical), Radel A® (produced by US's Amoco, and imported/sold by Teijin-Amoco Engineering) and Sumika Excel® (produced/sold by Sumitomo Chemical).

Polypheny sulfone resin (sometimes referred to as PPSU) is a polymer typically having a structure represented by the chemical formula (15).

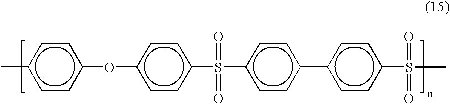

The commercial PPSU products useful for the present invention include Radel® R-series (R-5000, R-5500, R-5800 and so on, produced by US's Amoco, and imported/sold by Teijin-Amoco Engineering).

(6) Polysulfone-Based Resin Solution Composition

The polysulfone-based resin solution composition for the present invention contains at least one type of the above-described polysulfone-based resin dissolved in a mixed solvent comprising at least one of lactone (a) and aromatic ketone (b), cyclic ketone (c) and aliphatic ketone (d) boiling at 150° C. or lower. It is used for producing the surface-protective film of the present invention comprising a base film (A) which is laminated, at least on one side, with a polysulfone-based resin layer (B) formed by spreading and drying the polysulfone-based resin solution composition, to protect an adhesive silicone rubber layer (C).

The polysulfone-based resin solution composition is incorporated with the polysulfone-based resin at 1 to 30% by mass based on the mixed solvent, preferably 5 to 20%. The polysulfone-based resin content beyond the above range is not desirable. At below 1%, the coating layer of polysulfone-based resin will have a thickness below 0.1 μm, although the solution composition can be more spreadable because of reduced viscosity and have a longer service life. At above 30%, on the other hand, the solution composition is too viscous to give a coating polysulfone-based resin layer of uniform thickness and has a deteriorated service life.

The polysulfone-based resin solution composition may be incorporated with an antioxidant, UV absorber, antistatic agent, flame retardant, dye, pigment, lubricant, fungicide, rust-preventive agent, leveling agent or the like, as required. The leveling agents useful for the present invention include calcium perfluoroalkylsulfonate, potassium perfluoroalkylsulfonate, ammonium perfluoroalkylsulfonate, perfluoroalkyl ethylenoxide, perfluoroalkyl trimethyl ammonium salt and fluorinated alkyl ester.

The polysulfone-based resin layer (B) can be easily formed on the base film (A), preferably of polyethylene terephthalate, as a thin film having a thickness of 0.1 to 50 μm, preferably 1 to 3 μm, by solvent casting of a dope, i.e., polysulfone-based resin solution composition of at least one type of polysulfone-based resin dissolved in a mixed solvent comprising at least one of lactone (a) and aromatic ketone (b), cyclic ketone (c) and aliphatic ketone (d) boiling at 150° C. or lower, to provide a surface-protective film of high quality at a low cost.

The surface-protective film of the present invention is characterized by the polysulfone-based resin layer (B) surface flatness/smoothness with number of circular irregularities having a diameter of 50 μm or more, determined by a Nomarski differential interference microscope, of one or less per unit visual field area (1 mm²). This, in particular, secures high surface flatness/smoothness of the polysulfone-based resin layer (B) itself.

Surface flatness/smoothness of the polysulfone-based resin layer (B) was evaluated by a Nomarski differential interference microscope. It is difficult for a common optical microscope to observe the polysulfone-based resin layer (B), when it is transparent. On the other hand, a Nomarski differential interference microscope, which uses a special prism to produce interference fringes by dividing light beams into two parts and thereby to realize clearer light/dark contrasts, is suited for observing fine irregularities. It is considered that the layer (B) is excellent in surface flatness/smoothness and sufficiently glossy or highly transparent, when number of circular irregularities having a diameter of 50 μm or more is kept at one or less per unit visual field area (1 mm²). Moreover, the surface-protective film of the present invention, which has flat/smooth surface, will be free of problems, e.g., engulfing bubbles, while it is laminated on the adhesive silicon rubber layer (C). On the other hand, a surface having one or more circular irregularities having a diameter of 50 μm or more per unit visual field area (1 mm²) will involve problems, e.g., insufficient surface flatness/smoothness of the polysulfone-based resin layer (B), gloss or transparency. Moreover, production of a good laminate will be difficult with a surface-protective film of such surface conditions to be laminated on the adhesive silicon rubber layer (C), because of bubbles engulfed in the irregularities.

3. Surface-Protective Film and Method for Producing the Same

The surface-protective film of the present invention comprises a base film (A) which is laminated, at least on one side, with a polysulfone-based resin layer (B), and is used to protect an adhesive silicone rubber layer (C) to be bonded to a member, e.g., semiconductor device.

The base film (A), preferably of polyethylene terephthalate, is laminated on the polysulfone-based resin layer (B) at an adhesive strength of 5 N/m or more. It is essential that they are not separated from each other. The surface-protective film can be easily released from the adhesive silicone rubber layer (C), without causing any adverse effect on adhesion-related properties of the layer (C) and hence on achievement of the object of the present invention, because they are laminated on each other at a peel strength of 4 N/m or less, preferably 3 N/m or less, more preferably 2 N/m or less.

The surface-protective film of the present invention can be produced by coating the 10 to 200 μm thick base film (A), at least on one side, with the polysulfone-based resin layer (B) to a thickness of 0.1 to 50 μm, preferably 0.5 to 20 μm, more preferably 1 to 3 μm, where a polysulfone-based resin dope, i.e., polysulfone-based resin solution composition described earlier, is spread and dried on the base film (A).

The methods useful for the present invention for spreading the dope include roll, spray, die, knife, air knife and wire bar coating methods, of which wire bar coating is more preferable, because it can control flow rate of the solution composition to be spread more accurately to improve surface flatness/smoothness of the resulting coating layer and hence to give the surface-protective film of excellent surface flatness/smoothness. The polysulfone-based resin solution composition is preferably kept at 20 to 50° C. viewed from production cost, while it is spread on the base film.

The layer of the solution composition is preferably dried first at 25 to 40° C. and 70 to 100% RH for 2 to 10 minutes and then at 50 to 150° C. and 30 to 70% RH for 0.1 to 5 minutes.

The mixed solvent remains at 1000 mg/m² or less, preferably 800 mg/m² or less, more preferably 500 mg/m² or less, on and in the surface-protective film after it is used for forming the polysulfone-based resin layer (B). In other words, the total residual solvent quantity on and in the surface-protective film is kept within the above range. The total residual solvent quantity exceeding 1000 mg/m² is not desirable, because of anticipated troubles, e.g., deteriorated adhesiveness of the adhesive silicone rubber layer (C) and adverse effects on quality of a member to which the surface-protective film is bonded, e.g., adverse effects on functions of a semiconductor chip.

The present invention uses a mixed solvent comprising at least one of lactone (a) and aromatic ketone (b), cyclic ketone (c) and aliphatic ketone (d) boiling at 150° C. or lower, as described earlier. Disposal by incineration of the solvent components evaporated while the polysulfone-based resin solution composition is spread and dried on the base film should discharge no NOx, SOx or chloride. On the other hand, an organic solvent of nitrogen-containing compound (e.g., N-methyl-2-pyrrolidone or N,N-dimethylformamide), sulfur-containing compound (e.g., thiophene or dimethyl sulfoxide) or halogen-containing compound (e.g., dichloromethane or chloroform) is not environmentally desirable, because of possible discharge of NOx, SOx or chloride while the solvent component evaporated while the polysulfone-based resin solution composition is spread and dried is incinerated for disposal.

The total residual solvent quantity can be readily determined by gas chromatography (GC) or gas chromatography-mass spectroscopy (GC-MS).

The surface-protective film of the present invention is mainly to protect an adhesive silicone rubber layer (C) from dust while a semiconductor chip is bonded to a semiconductor chip mounting, and should be released when the layer (C) actually works.

The surface-protective film of the present invention, when provided with the adhesive silicone rubber layer (C) on each side, is bonded to the layer (C) at a peel strength of 4 N/m or less.

The adhesive silicone rubber layer (C) may be damaged, when the surface-protective film bonded at a peel strength above 4 N/m is released therefrom.

4. Adhesive Silicone Rubber Layer (C)

The adhesive silicone rubber layer (C) in the present invention works mainly to bond a semiconductor chip and semiconductor chip mounting. For example, it is an intermediate layer placed between two surface-protective films in such a way to come into contact with the polysulfone-based resin layer on each side.

The adhesive silicone rubber layer (C) is already crosslinked (cured) or semi-crosslinked (semi-cured), and the starting material therefor is a silicone rubber composition not crosslinked (cured) or semi-crosslinked (semi-cured), described below in detail.

The silicone rubber composition may be sometimes referred to as the crosslinkable silicone rubber composition, because it is crosslinkable although not crosslinked.

The starting material is therefore referred to as the crosslinkable silicone rubber composition in this specification, to be distinguished from the adhesive silicone rubber layer (C).

(1) Crosslinkable Silicone Rubber Composition

The crosslinkable silicone rubber composition for the present invention may be crosslinked by hydrosilylation, condensation, or with the aid of an organic peroxide or ultraviolet ray, preferably by hydrosilylation. One examples of the silicone rubber composition crosslinkable by hydrosilylation comprises (i) organopolysiloxane with at least two alkenyl groups in the molecule, each bound to silicon atom, (ii) organopolysiloxane with at least two hydrogen atoms in the molecule, each bound to silicon atom, (iii) adhesion promoter and (iv) hydrosilylation catalyst.

The component (i), which is a major component for the composition, is an organopolysiloxane with at least two alkenyl groups in the molecule, each bound to silicon atom. It may have a linear, partly branched linear, branched or network structure. The alkenyl group bound to silicon atom may be vinyl, allyl, butenyl, pentenyl or hexenyl group, of which vinyl group is particularly preferable. The alkenyl group may be bonded at a molecular chain terminal and/or side chain of a molecular chain.

The component (i) may also include a group, other than alkenyl, bound to silicon atom, such as alkyl (e.g., methyl, ethyl, propyl, butyl, pentyl, hexyl, heptyl or the like), aryl (e.g., phenyl, tolyl, xylyl, naphthyl or the like), aralkyl (benzyl, phenethyl or the like), or monovalent hydrocarbon group, which may be substituted or not, e.g., halogenated alkyl (e.g., chloromethyl, 3-chloropropyl, 3,3,3-trifluoropropyl or the like), of which methyl and phenyl are particularly preferable.

The silicone-based adhesive sheet produced has high resistance to cold weather and the semiconductor device including the sheet has improved reliability. Therefore, the component (i) has phenyl group preferably at 1% by mol or more based on the organic group bound to silicon atom, more preferably 1 to 60%, particularly preferably 1 to 30%. Viscosity of the component (i) is not limited. However, it is preferably in a range from 100 to 1,000,000 Pa·s (cP) at 25° C.

Next, the component (ii), which is an organopolysiloxane with at least two hydrogen atoms in the molecule, each bound to silicon atom, works as a crosslinking agent for the crosslinkable silicone rubber composition. It may have a linear, partly branched linear, branched, cyclic or network structure. The hydrogen atom may be bonded at a molecular chain terminal and/or side chain of a molecular chain.

The component (ii) may also include a group bound to silicon atom, such as alkyl (e.g., methyl, ethyl, propyl, butyl, pentyl, hexyl, heptyl or the like), aryl (e.g., phenyl, tolyl, xylyl, naphthyl or the like), aralkyl (benzyl, phenethyl or the like), or monovalent hydrocarbon group, which may be substituted or not, e.g., halogenated alkyl (e.g., chloromethyl, 3-chloropropyl, 3,3,3-trifluoropropyl or the like), of which methyl and phenyl are particularly preferable. Viscosity of the component (ii) is not limited. However, it is preferably in a range from 1 to 100,000 Pa·s (cP) at 25° C.

The crosslinkable silicone rubber composition contains the component (ii) at a sufficient content for crosslinking (curing) the composition, preferably 0.5 to 10 mols of hydrogen atom bound to silicon atom per mol of the alkenyl group bound to silicon atom in the composition, more preferably 1 to 5 mols. At a content of hydrogen atom below the lower limit, the composition may not be sufficiently cured. At a content above the upper limit, on the other hand, the composition tends to have reduced heat resistance.

The component (iii), working as an adhesion promoter for improving adhesiveness of the crosslinked product in the composition, may be of a silatrane derivative described below, silicone compound containing a functional group or organosiloxane oligomer.

The silatrane derivatives useful for the present invention are disclosed by JP-A 2001-19933 (Patent Document 4), 2000-265063, 2000-302977, 2001-261963, 2002-38014 and 2002-97273. Some of the representative ones are described below.

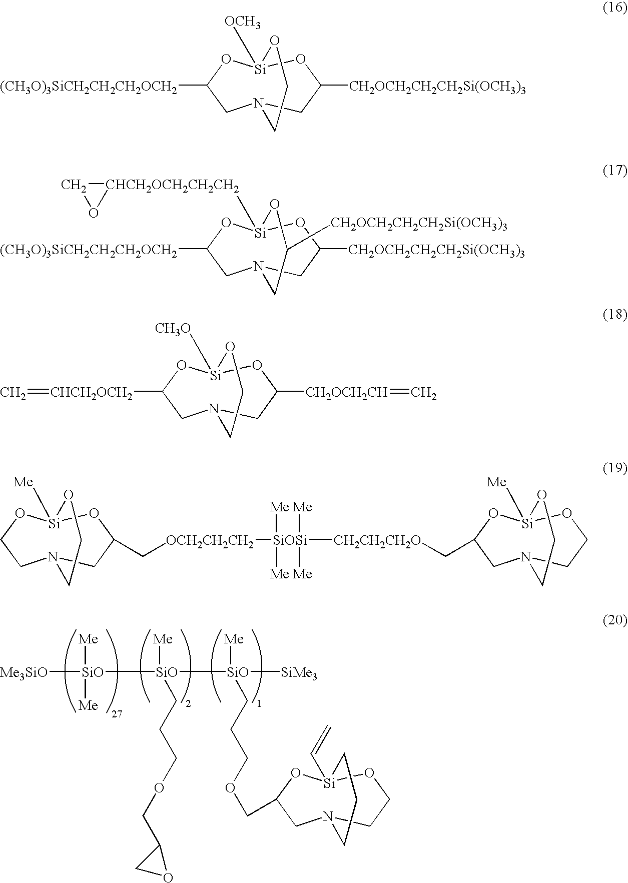

The silicone compounds containing a functional group include vinyl triethoxysilane, vinyl tris(2-methoxyethoxy) silane, 3-glycidoxypropyltrimethoxysilane, 2-(3,4-epoxycyclohexyl) ethyltrimethoxysilane, vinyl trimethoxysilane, 3-methacryloxypropyltrimethoxysilane, 3-acryloxypropyltrimethoxysilane, 3-aminopropyltrimethoxysilane, 3-aminopropyltriethoxysilane, N-(2-aminoethyl)-3-aminopropyltrimethoxysilane, N-(2-aminoethyl)-3-aminopropylmethyldimethoxysilane, N-phenyl-3-aminopropyltrimethoxysilane, 3-mercaptopropyltrimethoxysilane and 3-chloropropyltrimethoxysilane.

The organopolysiloxane oligomers useful for the present invention include the following compounds.

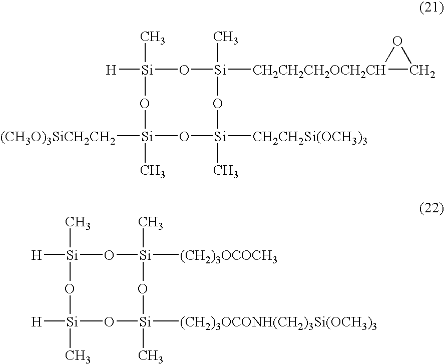

The crosslinkable silicone rubber composition contains the component (iii) at a sufficient content for imparting good adhesiveness to the adhesive silicone rubber layer (C). For example, the content is preferably 0.01 to 20% by mass based on the component (i), more preferably 0.1 to 10%. At a content below the lower limit, the adhesive silicone rubber layer (C) tends to have reduced adhesiveness. At a content above the upper limit, on the other hand, adhesiveness of the layer (C) is not improved much, but its stability tends to deteriorate.

The component (iv) works as a catalyst for promoting crosslinking of the crosslinkable silicone rubber composition by hydrosilylation. It may be selected from known hydrosilylation catalysts, e.g., those based n platinum, rhodium or palladium, of which a platinum-based one is more preferable for enhancing the reaction rate. These catalysts include those based on finely powdered platinum, platinum black, finely powdered silica impregnated with platinum, activated coal impregnated with platinum, chloroplatinic acid or alcohol solution thereof, olefin complex of platinum, alkenyl siloxane complex of platinum, or carbonyl complex of platinum.

The crosslinkable silicone rubber composition contains the component (iv) at a sufficient content for promoting crosslinking of the composition. When a platinum-based catalyst is used, the content is preferably in a range from 0.01 to 1,000 ppm by mass based on the platinum metal in the catalyst, particularly preferably 0.1 to 500 ppm by mass. At a content below the lower limit, the composition may be crosslinked at a much reduced rate. At a content above the upper limit, on the other hand, the crosslinking rate is not improved much, and the crosslinked product may have troubles, e.g., coloration.

The crosslinkable silicone rubber composition is preferably incorporated with a hydrosilyl inhibitor to control hydrosilylation rate. The inhibitors useful for the present invention include alkyne alcohols, e.g., 3-methyl-1-butyne-3-ol, 3,5-dimethyl-1-hexyne-3-ol and phenyl butynol; ene-yne compounds, e.g., 3-methyl-3-pentene-1-yne and 3,5-dimethyl-3-hexene-1-yne; and 1,3,5,7-tetramethyl-1,3,5,7-tetravinylcyclotetrasiloxane, 1,3,5,7-tetramethyl-1,3,5,7-tetrahexenylcyclotetrasiloxane and benzotriazole.

Content of the inhibitor varies depending on the composition crosslinking conditions. It is however in a range from 0.00001 to 5% by mass based on the component (i) for practical purposes.

The composition may be further incorporated with an optional component, e.g., inorganic filler (e.g., precipitated silica, wet silica, fumed silica, fired silica, titanium oxide, alumina, glass, quartz, aluminosilicate, iron oxide, zinc oxide, calcium carbonate, carbon black, silicon carbide, silicon nitride and boron nitride), which may be treated with an organosilicon compound (e.g., organohalosilane, organoalkoxysilane or organosilazane); finely powdered organic resin (e.g., silicone, epoxy or fluorine resin; filler of powdered electroconductive metal (e.g., silver or copper); or dye, pigment, flame retardant or solvent.

5. Laminate (Application of the Surface-Protective Film)

The surface-protective film of the present invention comprises the base film (A) laminated, at least on one side, with the polysulfone-based resin layer (B), as illustrated in FIG. 4, and is used to protect the adhesive silicone rubber layer (C). The surface-protective film and adhesive silicone rubber layer (C) are bonded to each other via the polysulfone-based resin layer (B) to constitute the laminate. The laminate preferably has an overall structure of A/B/C/B/A, in this order (refer to FIG. 5).

The A/B/C/B/A structure is a representative structure of the laminate. However, the other structures, e.g., B/A/B/C/B/A, A/B/C/B/A/B, B/A/B/C/B/A/B, A/B/C/B/A/B/C/B/A and A/B/C/B/A/B/C/B/A/B/C/B/A, may be also employed.

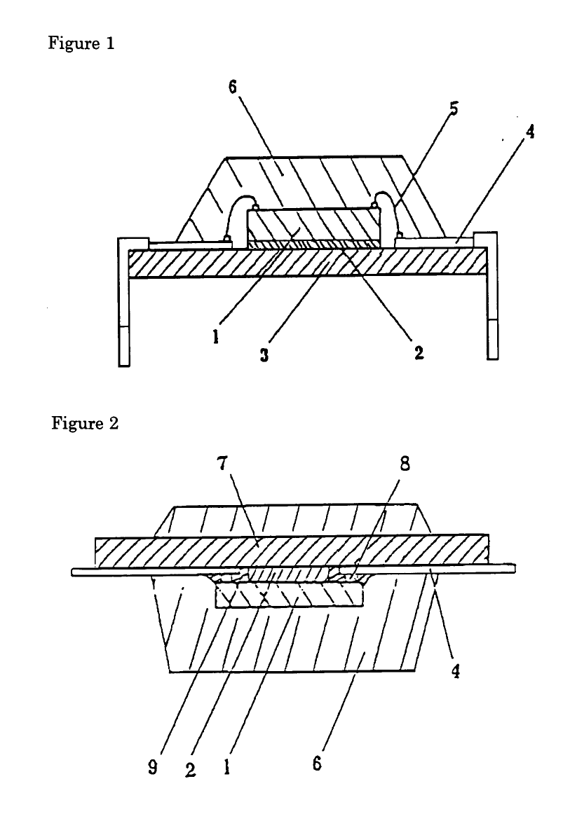

A semiconductor device, e.g., that shown in FIG. 1 or 2, is produced by removing the lower surface-protective film (B/A) from the laminate of A/B/C/B/A structure, bonding the exposed lower side of the adhesive silicone rubber layer (C) to the upper side of a semiconductor chip mounting, removing the upper surface-protective film (B/A) from the remaining laminate of A/B/C structure and bonding the exposed upper side of the adhesive silicone rubber layer (C) to the lower side of a semiconductor chip.

### EXAMPLES

The surface-protective film and laminate, both of the present invention, are described in detail by EXAMPLES, which by no means limit the present invention.

The surface-protective film and laminate were evaluated with respect to adhesiveness, peel strength, adhesive strength, surface flatness/smoothness and total residual solvent content, which were determined by the following procedures.

[Adhesiveness of the Adhesive Silicone Rubber Layer]

Two 3 by 3 cm silicon wafers were laid on top of another with a 1 by 1 cm adhesive silicone rubber layer in between, and the resulting laminate was heat-treated at 100° C. for 10 minutes while it was pressed at 5 kg/cm², to prepare the sample.

Moreover, two 3 by 3 cm polyimide films for FPCs were laid on top of another with a 1 by 1 cm adhesive silicone rubber layer in between, and the resulting laminate was heat-treated at 100° C. for 10 minutes while it was pressed at 5 kg/cm², to prepare the sample.

Each of these laminate samples was tensile-tested to determine cohesion failure rate (%) of the adhesive silicone rubber layer, i.e., aerial percentage of the cohesion-failed adhesive silicone rubber layer on the object to which it was bonded.

[Peel Strength Between Adhesive Silicone Rubber Layer and Surface-Protective Film]

The laminate was cut into 1 by 15 cm strips, which were tested by a tensile tester to release the surface-protective film on one side to 180° at 1000 mm/minute, to determine an average peeling stress, which was defined as peel strength.

[Adhesive Strength of Polysulfone-Based Resin Layer]

The surface-protective film coated with Sellotape® was cut into 2.5 by 15 cm strips, which were tested by a tensile tester to release the Sellotape layer to 180° at 1000 mm/minute, to determine an average peeling stress, which was defined as adhesive strength.

[Surface Flatness/Smoothness of Polysulfone-Based Resin Layer]

Surface flatness/smoothness of the polysulfone-based resin layer was evaluated by number of circular irregularities having a diameter of 50 μm or more per unit visual field area (1 mm²), determined by a Nomarski differential interference microscope. The sample having one or less irregularities was regarded to pass the test.

[Total Residual Solvent Content of Surface-Protective Film]

A 5 mm square sample of the surface-protective film (250 by 200 mm) was dissolved in 10 ml of chloroform at room temperature for 24 hours in a 50 ml glass sample bottle to prepare the sample for gas chromatography, to determine total residual solvent content (mg/m²), i.e., mass of the mixed solvent remaining per 1 m² of the surface-protective film.

Materials or the like for the surface-protective films prepared in EXAMPLES and COMPARATIVE EXAMPLES are described below.

PET (Polyethylene terephthalate) film for the base film (A) was Toray Industries' “Lumirror QT-32” (50 μm thick).

Polyether sulfone resin for the polysulfone-based resin layer (B) was Sumitomo Chemical's “Sumika Excel PES5200G.”

Materials and the like for the adhesive silicone rubber layer (C) prepared in EXAMPLES and COMPARATIVE EXAMPLES are described below.

[Materials for Adhesive Silicone Rubber Layer]

A mixture comprising 72 parts of dimethyl polysiloxane (viscosity: 40,000 mPa·s at 25° C., sealed with dimethyl vinyl siloxy group at both ends of the molecular chain, vinyl group content: 0.08% by mass), 15 parts of dimethylsiloxane/methyl vinyl siloxane copolymer (viscosity: 6,000 mPa·s at 25° C., sealed with dimethyl vinyl siloxy group at both ends of the molecular chain, vinyl group content: 0.84% by mass), 1.5 parts of water, 3 parts of hexamethyl disilazane and 10 parts of finely powdered dry silica (BET specific surface area: 200 m²/g), all parts by mass, was prepared by Ross mixer for 1 hour, then treated at 170° C. for 2 hours under a vacuum, and cooled to room temperature, to prepare a semi-transparent, pasty silicone rubber base.

Next, 100 parts of the silicone rubber base was uniformly incorporated with 3 parts of dimethyl siloxane/methyl hydrogen siloxane copolymer (viscosity: 5 mPa·s at 25° C., sealed with trimethyl siloxy group at both ends of the molecular chain, content of hydrogen atom bound to silicon atom: 0.7% by mass), 1.0 part of a silatrane derivative (prepared in REFERENCE EXAMPLE 1, described below), 1,3-divinyl-1,1,3,3-tetramethyl disiloxane complex of platinum at 5 ppm by mass of platinum metal based on the composition, and 0.01 parts of 3-phenyl-1-butyne-3-ol, all parts by mass, to prepare a silicone rubber composition cross-linkable by hydrosilylation (viscosity: 70,000 mPa·s at 25° C.).

The crosslinkable silicone rubber composition, placed between surface-protective films, was pressed to a thickness of 200 μm by two stainless steel rolls with an adjusted clearance, and heat-treated at 80° C. for 30 minutes in a hot wind circulation type oven, to prepare the laminate with the crosslinked silicone rubber composition.

### Reference Example 1

(Preparation of Silatrane Derivative)

A 500 ml, 4-mouthed flask provided with a stirrer, thermometer and reflux condenser, was charged with 12.2 g (0.2 mols) of 2-hydroxyethylamine, 88.9 g (0.6 mols) of vinyl trimethoxy silane, 94.5 g (0.4 mols) of 3-glycidoxypropyltrimethoxy silane and 32 g of methanol, and the mixture was heated for 8 hours with stirring at methanol reflux temperature.

The reaction mixture thus prepared was totally transferred to an egg-plant type flask, and treated by a rotary evaporator to distill off low boiling components to prepare 132 g of a slightly yellowish transparent liquid.

The transparent liquid contained the silatrane derivative, represented by the formula (23) at 90% by mass or more, as confirmed by 29Si nuclear magnetic resonance and 13C nuclear magnetic resonance.

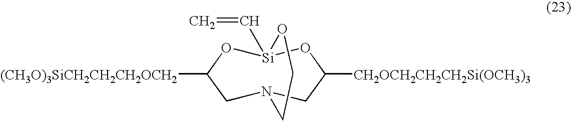

### Example 1

(i) Preparation of Polyether Sulfone Resin Solution Composition

First, 100 parts by volume of a mixed solvent comprising 40 parts by volume of acetophenone, 30 parts by volume of cyclohexanone and 30 parts by volume of methylethylketone was incorporated with 10 parts by mass of polyether sulfone resin (PES, Sumika Excels PES5003P, Sumitomo Chemical), and stirred for 24 hours to prepare a polyether sulfone resin solution composition.

(ii) Preparation of Surface-Protective Film (1) and Laminate (1)

A dope of the polyether sulfone resin solution composition was spread and dried on one side of a PET film (Lumirror QT32, thickness: 50 μm, Toray Industries) by reverse roll coater, to prepare a surface-protective film (1) coated with a 2 μm thick (dry basis) polyether sulfone resin layer.

The surface-protective film (1) was laminated on an adhesive silicone rubber layer (C) by the procedure described earlier, to prepare a laminate (1).

(iii) Evaluation

The surface-protective film (1) and laminate (1) had the following properties; adhesiveness: 100%, peel strength: 0.9 N/m, adhesive strength: 20 N/m, surface flatness/smoothness: one or less circular irregularities having a diameter of 50 μm or more per unit visual field area (1 mm²) and total residual solvent content: 200 mg/m² or less. The laminate (1), when punched out by a Thomson punching machine, produced only a limited quantity of filamentous (or whisker-like) debris. Therefore, they are of sufficient quality as a surface-protective film and laminate.

### Example 2

(i) Preparation of Polyether Sulfone Resin Solution Composition

First, 100 parts by volume of a mixed solvent comprising 40 parts by volume of γ-butyrolactone, 30 parts by volume of cyclohexanone and 30 parts by volume of methylethylketone was incorporated with 10 parts by mass of polyether sulfone resin (PES, Sumika Excel® PES5003P, Sumitomo Chemical), and stirred for 24 hours to prepare a polyether sulfone resin solution composition.

(ii) Preparation of Surface-Protective Film (2) and Laminate (2)

A dope of the polyether sulfone resin solution composition was spread and dried on one side of a PET film (Tetron HS, thickness: 50 μm, Teijin DuPont) by reverse roll coater, to prepare a surface-protective film (2) coated with a 2 μm thick (dry basis) polyether sulfone resin layer.

The surface-protective film (2) was laminated on an adhesive silicone rubber layer (C) by the procedure described earlier, to prepare a laminate (2).

(iii) Evaluation

The surface-protective film (2) and laminate (2) had the following properties; adhesiveness: 100%, peel strength: 1.0 N/m, adhesive strength: 25 N/m, surface flatness/smoothness: one or less circular irregularities having a diameter of 50 μm or more per unit visual field area (1 mm²) and total residual solvent content: 200 mg/m² or less. The laminate (2), when punched out by a Thomson punching machine, produced only a limited quantity of filamentous (or whisker-like) debris. Therefore, they are of sufficient quality as a surface-protective film and laminate.

### Example 3

(i) Preparation of Polyether Sulfone Resin Solution Composition

First, 100 parts by volume of a mixed solvent comprising 30 parts by volume of acetophenone, 50 parts by volume of cyclohexanone and 20 parts by volume of methylethylketone was incorporated with 10 parts by mass of polyether sulfone resin (PES, Sumika Excel® PES5003P, Sumitomo Chemical), and stirred for 24 hours to prepare a polyether sulfone resin solution composition.

(ii) Preparation of Surface-Protective Film (3) and Laminate (3)

A dope of the polyether sulfone resin solution composition was spread and dried on one side of a PET film (Tetron HS, thickness: 50 μm, Teijin DuPont) by reverse roll coater, to prepare a surface-protective film (3) coated with a 2 μm thick (dry basis) polyether sulfone resin layer.

The surface-protective film (3) was laminated on an adhesive silicone rubber layer (C) by the procedure described earlier, to prepare a laminate (3).

(iii) Evaluation

The surface-protective film (3) and laminate (3) had the following properties; adhesiveness: 100%, peel strength: 0.9 N/m, adhesive strength: 20 N/m, surface flatness/smoothness: one or less circular irregularities having a diameter of 50 μm or more per unit visual field area (1 mm²) and total residual solvent content: 200 mg/m² or less. The laminate (3), when punched out by a Thomson punching machine, produced only a limited quantity of filamentous (or whisker-like) debris. Therefore, they are of sufficient quality as a surface-protective film and laminate.

### Example 4

(i) Preparation of Polyether Sulfone Resin Solution Composition

First, 100 parts by volume of a mixed solvent comprising 30 parts by volume of γ-butyrolactone, 30 parts by volume of cyclohexanone and 40 parts by volume of methylethylketone was incorporated with 10 parts by mass of polyether sulfone resin (PES, Sumika Excel® PES5003P, Sumitomo Chemical), and stirred for 24 hours to prepare a polyether sulfone resin solution composition.

(ii) Preparation of Surface-Protective Film (4) and Laminate (4)

A dope of the polyether sulfone resin solution composition was spread and dried on one side of a PET film (Tetron HS, thickness: 50 μm, Teijin DuPont) by reverse roll coater, to prepare a surface-protective film (4) coated with a 2 μm thick (dry basis) polyether sulfone resin layer.

The surface-protective film (4) was laminated on an adhesive silicone rubber layer (C) by the procedure described earlier, to prepare a laminate (4).

(iii) Evaluation

The surface-protective film (4) and laminate (4) had the following properties; adhesiveness: 100%, peel strength: 0.9 N/m, adhesive strength: 20 N/m, surface flatness/smoothness: one or less circular irregularities having a diameter of 50 μm or more per unit visual field area (1 mm²) and total residual solvent content: 200 mg/m² or less. The laminate (4), when punched out by a Thomson punching machine, produced only a limited quantity of filamentous (or whisker-like) debris. Therefore, they are of sufficient quality as a surface-protective film and laminate.

### Comparative Example 1

(i) Preparation of Surface-Protective Film (5)

A PET film (Lumirror QT32, thickness: 50 μm, Toray Industries) was used as a surface-protective film (5).

It was not coated with a polysulfone-based resin film.

(ii) Preparation of Laminate (5)

The surface-protective film (5) was laminated on an adhesive silicone rubber layer (C) by the procedure described earlier, to prepare a laminate (5).

(iii) Evaluation

The surface-protective film (5) and laminate (5) were bonded to the adhesive silicone rubber layer at a too high peel strength to be released therefrom. Therefore, they are of insufficient quality as a surface-protective film and laminate.

### Comparative Example 2

(i) Preparation of Surface-Protective Film (6)

A PES film, described below, was prepared as a surface-protective film (6). It was of a single-layer structure, in which a PES film was used as a base.

A PES resin (Sumika Excel® PES5200G, Sumitomo Chemical) was dried at 160° C. for 8 hours to reduce moisture content to 0.08% by mass. The PES pellets thus treated was molten and extruded at 300° C. by an extruder equipped with a T-die, and cooled and solidified to prepare a 75 μm thick PES film.

(ii) Preparation of Laminate (6)

The surface-protective film (6) was laminated on an adhesive silicone rubber layer (C) by the procedure described earlier, to prepare a laminate (6).

(iii) Evaluation

The surface-protective film (6) and laminate (6) were acceptable with respect to peel strength (1.1 N/m) and adhesiveness (95%). However, it produced a lot of filamentous (or whisker-like) debris, when punched out by a Thomson punching machine. Therefore, they are of insufficient quality as a surface-protective film and laminate.

### Comparative Example 3

(i) Preparation of Polyether Sulfone Resin Solution Composition

Dimethylformamide (DMF) was incorporated with a PES resin (Sumika Excel® PES5003P, Sumitomo Chemical) at 10% by mass, and stirred for 24 hours to prepare a polyether sulfone resin solution composition.

(ii) Preparation of Surface-Protective Film (7) and Laminate (7)

A dope of the polyether sulfone resin solution composition was spread and dried on one side of a PET film (Tetron HS, thickness: 50 μm, Teijin DuPont) by reverse roll coater, to prepare a surface-protective film (7) coated with a 2 μm thick (dry basis) polyether sulfone resin layer.

The surface-protective film (7) was laminated on an adhesive silicone rubber layer (C) by the procedure described earlier, to prepare a laminate (7).

(iii) Evaluation

The surface-protective film (7) and laminate (7) had the following properties; adhesiveness: 100%, peel strength: 7 N/m, adhesive strength: 13 N/m, surface flatness/smoothness: 4 circular irregularities having a diameter of 50 μm or more per unit visual field area (1 mm²). Moreover, it had a total residual solvent content of 1200 mg/m², although producing a limited quantity of filamentous (or whisker-like) debris or less, when punched out by a Thomson punching machine. Therefore, they are of insufficient quality as a surface-protective film and laminate.

These evaluation results are summarized in Table 1.

TABLE 1

| | | EXAMPLE | EXAMPLE | EXAMPLE | EXAMPLE | COMPARATIVE | COMPARATIVE | COMPARATIVE |
|---|---|---|---|---|---|---|---|---|
| | | 1 | 2 | 3 | 4 | EXAMPLE 1 | EXAMPLE 2 | EXAMPLE 3 |
| (1) Base film (A) | | PET | PET | PET | PET | PET | PES | PET |
| | | (Lumirror) | (Tetron) | (Tetron) | (Tetron) | (Lumirror) | | (Tetron) |
| (2) Polysulfone-based | | | | | | | | |
| resin layer (B) | | | | | | | | |
| Coating film | μm | 2 | 2 | 2 | 2 | — | — | 2 |
| (thickness on | | | | | | | | |
| dry basis) | | | | | | | | |
| Polysulfone-based resin | | | | | | — | — | |
| solution composition | | | | | | | | |
| Resin | | PES | PES | PES | PES | — | — | PES |
| Resin content | % by mass | 10 | 10 | 10 | 10 | — | — | 10 |
| Mixed solvent | % by mass | 90 | 90 | 90 | 90 | — | — | 90 |
| Mixed solvent | % by volume | 100 | 100 | 100 | 100 | — | — | 100 |
| Acetophenone | % by volume | 40 | — | 30 | — | — | — | — |
| GBL | % by volume | — | 40 | — | 30 | — | — | — |
| Cyclohexanone | % by volume | 30 | 30 | 50 | 30 | — | — | — |
| MEK | % by volume | 30 | 30 | 20 | 40 | — | — | — |
| DMF | % by volume | — | — | — | — | — | — | 100 |
| Evaluation result of surface- | | | | | | | | |
| protective films (laminates) | | | | | | | | |
| Surface-protective film | | PES/ | PES/ | PES/ | PES/ | PET | PES | PES/PET |
| | | PET | PET | PET | PET | | | |
| Adhesiveness | % | 100 | 100 | 100 | 100 | — | 95 | 100 |
| Peel strength | N/m | 0.9 | 1.0 | 0.9 | 0.9 | Impossible to | 1.1 | 7 |
| | | | | | | release | | |
| Adhesive | N/m | 20 | 25 | 20 | 20 | — | — | 13 |
| strength | | | | | | | | |
| Surface flatness/ | Number of | <1 | <1 | <1 | <1 | — | — | 4 |
| smoothness | irregularities/ | | | | | | | |
| | mm² | | | | | | | |
| Total residual | mg/m² | <200 | <200 | <200 | <200 | — | — | 1200 |
| solvent content | | | | | | | | |
| Debris produced | | ◯ | ◯ | ◯ | ◯ | ◯ | X | ◯ |
| by punching*1 | | | | | | | | |
| Overall evaluation | | ◯ | ◯ | ◯ | ◯ | X | X | X |

*1◯: Limited quantity of filamentous (or whisker-like) debris produced by punching
X: A lot of filamentous (or whisker-like) debris produced by punching

The surface-protective film of the present invention has no adverse effect on surface flatness of an adhesive silicone rubber layer which it protects, because it can be easily released from the adhesive silicone rubber layer, contains no residual solvent which may aversely affect adhesiveness of the adhesive silicone rubber layer to a semiconductor chip and semiconductor chip mounting, and is itself excellent in surface flatness/smoothness. Moreover, the surface-protective film can give a highly reliable semiconductor device, because it can be easily released from the adhesive silicone rubber layer, while keeping the adhesive silicone rubber layer highly adhesive to the semiconductor chip and semiconductor chip mounting.

1. A surface-protective film comprising abase film (A) which is laminated, at least on one side, with a polysulfone-based resin layer (B) to protect an adhesive silicone rubber layer (C), wherein
the polysulfone-based resin layer (B) is of a polysulfone-based resin solution composition of at least one type of polysulfone-based resin dissolved in a mixed solvent comprising at least one of lactone (a) and aromatic ketone (b), cyclic ketone (c) and aliphatic ketone (d) boiling at 150° C. or lower.

2. The surface-protective film according to claim 1, wherein the polysulfone-based resin layer (B) has surface flatness/smoothness with number of circular irregularities having a diameter of 50 μm or more, determined by a Nomarski differential interference microscope, of one or less per unit visual field area (1 mm²).

3. The surface-protective film according to claim 1, wherein the base film (A) and polysulfone-based resin layer (B) are bonded to each other at an adhesive strength of 5 N/m or more.

4. The surface-protective film according to claim 1, wherein the base film (A) is of polyethylene terephthalate.

5. The surface-protective film according to claim 1, wherein the mixed solvent is contained in the film at 1000 mg/m² or less.

6. The surface-protective film according to claim 1, wherein the base film (A) is 10 to 200 μm thick and the polysulfone-based resin layer (B) is 0.1 to 50 μm thick.

7. The surface-protective film according to claim 1 which is released from the adhesive silicone rubber layer (C) at a peel strength of 4 N/m or less.

8. A method for producing the surface-protective film of claim 7, wherein the adhesive silicone rubber layer (B) is formed by spreading and drying a dope of polysulfone-based resin on at least one side of the base film (A).

9. A method for producing the surface-protective film of claim 1, wherein the adhesive silicone rubber layer (B) is formed by spreading and drying a dope of polysulfone-based resin on at least one side of the base film (A).

10. A method for producing the surface-protective film of claim 2, wherein the adhesive silicone rubber layer (B) is formed by spreading and drying a dope of polysulfone-based resin on at least one side of the base film (A).

11. A method for producing the surface-protective film of claim 3, wherein the adhesive silicone rubber layer (B) is formed by spreading and drying a dope of polysulfone-based resin on at least one side of the base film (A).

12. A method for producing the surface-protective film of claim 4, wherein the adhesive silicone rubber layer (B) is formed by spreading and drying a dope of polysulfone-based resin on at least one side of the base film (A).

13. A method for producing the surface-protective film of claim 5, wherein the adhesive silicone rubber layer (B) is formed by spreading and drying a dope of polysulfone-based resin on at least one side of the base film (A).

14. A method for producing the surface-protective film of claim 6, wherein the adhesive silicone rubber layer (B) is formed by spreading and drying a dope of polysulfone-based resin on at least one side of the base film (A).
